(19) United States
(12) Patent Application Publication
(10) Pub. No.: US 2026/0352596 A1
(43) Pub. Date: Nov. 5, 2026

(54) DISTRIBUTED FLOW MONITORING

(71) Applicant: Hewlett Packard Enterprise Development LP, Spring, TX (US)

(72) Inventors: Andrew Jon Gailey, East Aurora, NY (US); Duncan Roweth, Bristol (GB); Christophe W. Lemuet, Bristol (GB)

(21) Appl. No.: 19/194,868

(22) Filed: Apr. 30, 2025

(51) Int. Cl. H04L 47/11; H04L 41/0631; H04L 41/0686; H04L 43/0882; H04L 43/10

(52) U.S. Cl. CPC H04L 47/11; H04L 41/0631; H04L 41/0686; H04L 43/0882; H04L 43/10

(57) ABSTRACT

One aspect provides a system and method for detecting the root cause of congestion in a network. During operation, the system may monitor flows on a respective node within a network comprising a plurality of nodes, the node comprising a number of receiving ports and a number of transmitting ports. In response to detecting a stalling event associated with a flow at a receiving port, the system may determine whether transmission of the flow is stalled at the node. In response to determining that transmission of the flow is not stalled, the system may determine that the node comprises an original point of congestion causing the flow to stall. In response to determining that transmission of the flow is stalled, the system may send a trace-flow message associated with the flow to a downstream node, the trace-flow message facilitating the downstream node in identifying the original point of congestion.

### STATEMENT OF GOVERNMENT-FUNDED RESEARCH

This invention was made with Government support under Contract Number H98230-23-C-0350 awarded by the Maryland Procurement Office. The Government has certain rights in this invention.

### BACKGROUND

### Field

This disclosure relates to congestion management in networks. More specifically, this disclosure relates to implementing distributed flow monitoring to mitigate performance degradation in networks.

### Related Art

Many latency-sensitive applications (e.g., deep learning, real-time big-data analysis, high-performance computing (HPC), etc.) deployed in modern data centers rely on direct memory access (DMA) technologies to reduce latency. DMA protocols often require guaranteed data deliveries to achieve the best performance. However, the flow control mechanism implemented in such networks (e.g., Priority-based Flow Control (PFC) in Converged Enhanced Ethernet (CEE) or Credit-Based Flow Control (CBFC) in InfiniBand) may lead to congestion propagation, which may degrade the network performance.

### BRIEF DESCRIPTION OF THE FIGURES

FIG. 1 illustrates formation of a congestion tree and detection of the root cause, according to one aspect of the instant disclosure.

FIG. 2A presents a flowchart illustrating an example process for determining the cause of a stalled flow in the receiving direction, according to one aspect of the instant disclosure.

FIG. 2B illustrates an example process for determining the cause of a stalled flow based on a trace-flow message, according to one aspect of the instant disclosure.

FIG. 3 presents a flowchart illustrating an example process for determining the cause of a stalled flow in the transmitting direction, according to one aspect of the instant disclosure.

FIG. 4 illustrates an example functional block diagram of a network device, according to one aspect of the instant disclosure.

FIG. 5 illustrates a computer-readable medium (CRM) that facilitates the detection and isolation of the root cause of congestion, according to one aspect of the instant disclosure.

In the figures, like reference numerals refer to the same figure elements.

### DETAILED DESCRIPTION

In an Ethernet network implementing PFC, when congestion occurs at a switch port, pause frames are sent upstream to halt traffic for the affected priority class. This backpressure propagates recursively, causing upstream switches to buffer or pause their transmissions. Each paused node (e.g., a switch or host) becomes a new congestion point, propagating pauses further upstream and forming a congestion tree rooted at the initial congestion point. In a network that employs multi-path or adaptive routing, congestion trees may be formed rapidly, significantly degrading the network-wide throughput.

Once congestion is spread widely in the network, it can be challenging to distinguish the original point of congestion from its victims. Packet drops, errors, and timeouts may be observed throughout the entire network, with no indication of priority or causality. Timely identification of the root cause of congestion is critical to preventing systemic performance degradation.

The present disclosure provides a distributed system that monitors multiple potential points of congestion in the network to identify the root cause. The distributed system may include a flow-monitoring agent deployed to a plurality of nodes in the network to detect stalled flows. Communications among the flow-monitoring agents may facilitate the detection and isolation of the root cause.

As used herein, the term “node” may refer to one or more computing devices configured to emulate one or more, or all, of the functions described herein. As used herein, a “computing device” may be a server, a cluster of servers, a storage array, a computer appliance, a workstation, a desktop computer, a laptop computer, a switch, a router, or any other processing device or equipment including a processing resource. In an example, the node may include a processing resource communicatively coupled to at least one non-transitory computer-readable storage medium including instructions that, when executed by the processing resource, cause the node to undertake certain actions and functionalities as described herein.

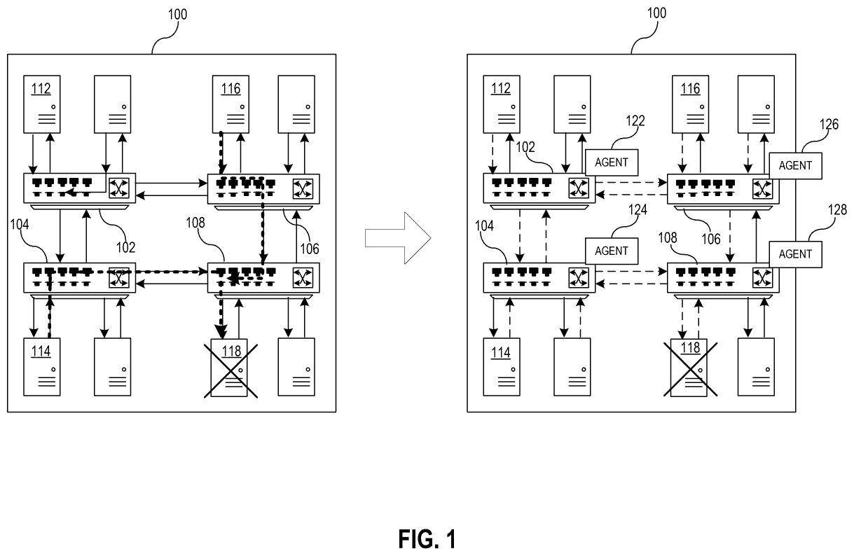

FIG. 1 illustrates formation of a congestion tree and detection of the root cause, according to one aspect of the instant disclosure. The left portion of FIG. 1 shows the beginning moment of congestion in a network 100, which includes a plurality of interconnected switches (e.g., switches 102, 104, 106, and 108) and a plurality of hosts (e.g., hosts 112, 114, 116, and 118) coupled to the switches. In this example, hosts 112, 114, 116, and 118 are coupled to switches 102, 104, 106, and 108, respectively.

In the example shown in FIG. 1, a software or hardware failure at host 118 renders it unreachable to incoming traffic from hosts 114 and 116. The attempted communication paths are shown as dashed arrows in FIG. 1. The failure at host 118 causes congestion at switch 108. Switch 108, unable to forward packets to the unresponsive host 118, applies flow control back on the upstream switches 104 and 106), causing packet accumulation in their buffers. When buffers at switches 104 and 106 exceed their respective capacity threshold, each switch may apply flow control upstream (e.g., to switch 102). As time passes and more traffic is injected into the network (e.g., by host 112 or other network endpoints), a congestion tree may grow and cause widespread congestion in network 100.

The right portion of FIG. 1 illustrates the congestion tree originating from the failure of host 118, with dashed arrows indicating links impacted by stalled traffic. As congestion propagates upstream (e.g., to switches 104, 106, and 102), the hierarchical structure of the tree obscures the root-cause node (i.e., host 118), making it challenging to differentiate the initial failure from upstream collateral effects. The root cause of congestion can vary in severity and may require different mitigation efforts. For example, a poorly designed application may cause a long-lived incast, which may eventually clear up on its own. A sub-optimal network configuration could result in unnecessarily high throttling in response to congestion, which should also clear up on its own. On the other hand, an uncorrectable error or invalid network configuration could result in broken flow control, which requires corrective action to return the network to a healthy state. In many cases, congestion is likely to return if the underlying issue is not resolved. The identification of the root cause of congestion is essential.

According to some aspects of the instant disclosure, a network may implement a distributed flow-monitoring system to monitor flows and detect and isolate the root cause of congestion. The distributed flow-monitoring system may include a flow-monitoring agent running on each switch (and optionally on some hosts) to monitor signs of stalled flows. In the example shown in FIG. 1, each switch may run a flow-monitoring agent. For example, switch 102 runs an agent 122, switch 104 runs an agent 124, switch 106 runs an agent 126, and switch 108 runs an agent 128. The flow-monitoring agent may be running on the controller of each switch. Some or all hosts (e.g., hosts 112-118) may also be running the flow-monitoring agent.

A flow-monitoring agent running on a switch may observe a stalled flow and communicate with its peers to trace the stalled flow downstream to identify the original point of congestion causing the flow to stall. The original point of congestion is either the destination of the flow or some point between the current switch and the destination, from which point the upstream progress is stalled, but the downstream progress is not. The agents may begin monitoring the flows before any traffic enters the network and monitor every potential point of failure, including at least every receiving (RX) and transmitting (TX) port of the network node. Because every point of failure is actively monitored, the primary point of failure (i.e., the root cause of congestion) should always be among the first to be discovered, significantly narrowing the search domain. Furthermore, if a known root cause can be identified quickly, it may be corrected in time before the congestion spreads to the rest of the network.

Each flow-monitoring agent may access certain locally available information to detect stalling events. Examples of the stalling events may include but are not limited to: a hardware failure, a hardware timeout event, the number of dropped or stalled packets exceeding a predetermined threshold, the utilization of the buffer space exceeding a predetermined threshold, the number of received pause frames exceeding a predetermined threshold (which can indicate sustained backpressure), the exhaustion of the transmitting credits, etc.

A switch may maintain flow state information at each port. Each flow-monitoring agent may be configured to independently monitor flows in the RX and TX channels of each port by obtaining the flow state information to determine the direction of an affected flow, thus allowing the agent to trace the problem downstream. In some examples, the flow-monitoring agent may monitor the receiving and transmitting buffers to determine whether the flow is stalled (e.g., without making sufficient progresses) on the transmitting or receiving side.

Each flow-monitoring agent may communicate with its direct peers (e.g., flow-monitoring agents running on its link partners) to trace the stalled flow downstream from one agent to the next. Communication among the agents is not to be affected by congestion in the network. For example, agent 122 may communicate with agent 124 or 126 to trace a stalled flow, and such communication is isolated from the stalling that it is meant to trace (i.e., it should not be affected by the congestion causing the flow to stall). According to some aspects, communications among the flow-monitoring agents may be achieved via out-of-band channels. Alternatively, each flow-monitoring agent may communicate with its peers in-band using a separate traffic class or control messages.

A flow-monitoring agent may report its findings to allow the network operator to diagnose and correct the underlying issue. In certain scenarios, the problem causing the congestion may be corrected automatically without human intervention.

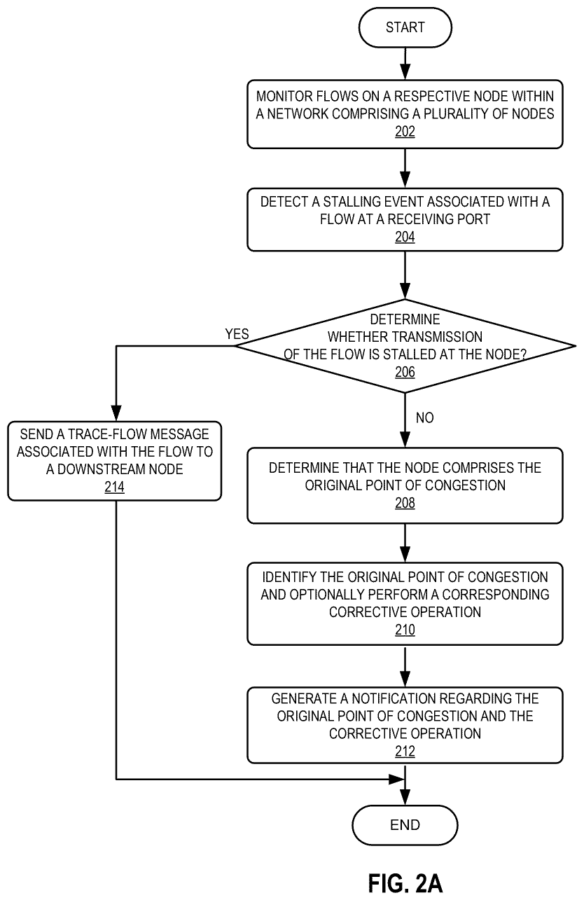

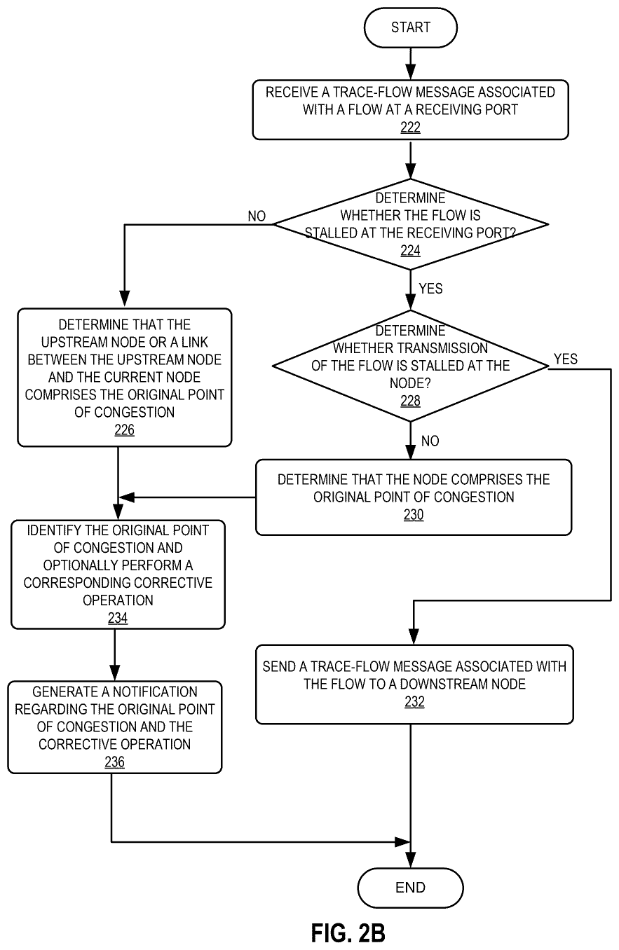

FIG. 2A presents a flowchart illustrating an example process for determining the cause of a stalled flow in the receiving direction, according to one aspect of the instant disclosure. During operation, a flow-monitoring agent monitors flows on a respective node within a network comprising a plurality of nodes (operation 202). The network node may be a switch (e.g., an Ethernet switch) having multiple receiving ports and transmitting ports, and the flow-monitoring agent may run on the switch controller. The flow-monitoring agent may monitor flows going through the switch in both the receiving and transmitting directions. Each flow may comprise a sequence of related packets with the same source and destination end points and may also have other similar properties, such as belonging to the same traffic class, or being part of a single communication, for example, as in the case of a TCP flow.

In some examples, the interconnected switches (referred to as a switch network or switch fabric) may use a flow-based traffic-management mechanism (e.g., flow channels) to provide in-order delivery of packets with adaptive routing and to apply congestion management to individual streams of traffic (i.e., flows). A flow channel is essentially the virtual or logical pathway through which a continuous stream of related data packets (e.g., a flow) travels between two network nodes. As each packet enters the switch fabric, it is assigned to a new or existing flow channel based on its source, destination, and other quality-of-service values. Each flow channel may be marked by a distinctive identifier (e.g., a flow ID). For example, the ingress switch of a fabric may assign a flow ID to packets belonging to the same flow. This flow ID may be a locally significant value specific to the incoming link. When the packets are forwarded to the next-hop switch, the packets enter another link, and a new flow ID may be selected for the next flow channel of the next link. Each link may have its own set of flow channels in each direction identified by their respective flow IDs. As the packets of a flow traverse multiple links and switch nodes, the flow IDs corresponding to this flow can form a unique chain of flow channels. As traffic moves through the switch fabric, flow channels are constantly being allocated and freed.

Each flow may be represented using a chain of Flow Channel Table (FCT) entries between source and destination. Each switch may maintain an input flow channel table (IFCT) and an output flow channel table (OFCT) for each port to track traffic in and out of the switch. At a switch, the flow ID of an incoming packet may be used to map an entry in the IFCT. When the packet is forwarded to the next-hop switch, the packet enters another link, and a new flow ID may be selected for the next flow channel of the next link. The mapping between the incoming flow ID and the outgoing flow ID may be stored in the OFCT. As data packets belonging to a flow travel forward along its path, data counters are incremented in the corresponding FCT entry. As acknowledgment packets (ACKs) travel backward along this path, ACK counters are incremented. When the two counters are equal, all packets downstream of an entry have been ACKed, and the entry may be freed for use by a new flow. The flow-monitoring agent may monitor the advancement of the counters.

The flow-monitoring agent may detect a stalling event associated with a flow at a receiving port (operation 204). More specifically, the flow-monitoring agent may monitor the state of each flow at the receiving port. When flow channels are implemented, switch hardware may monitor the FCTs (including the IFCT and OFCT of each port) to detect the stalling event. In some examples, a stalling event may be detected when an FCT entry does not make forward progress for a configurable amount of time and reports a timeout through error flags, counters, and a timeout bit in the entry itself. In one example, the flow-monitoring agent may detect that a counter for an FCT entry corresponding to an active flow has not incremented for a configurable amount of time, indicating that the flow is stalled.

The flow-monitoring agent may determine whether the transmission of the flow is stalled (operation 206). For example, the flow-monitoring agent may determine whether the detected stalling event is associated with the transmission of the flow (e.g., a timed-out OFCT entry).

If the transmission of the flow is not stalled, the flow-monitoring agent may determine that the current node comprises the original point of congestion (operation 208). As discussed previously, the original point of congestion is the point where the upstream progress is stalled, but the downstream progress is not.

The flow-monitoring agent may further identify the original point of congestion and optionally perform a corresponding corrective operation (operation 210). The flow-monitoring agent may identify the root cause of the congestion by analyzing event logs or running diagnosis tests. For example, the node may have a hardware failure or certain configuration errors on the node. The flow-monitoring agent may identify the failed hardware component on the switch or the type of configuration errors. The switch controller may correct the identified configuration error automatically. In another example, an uncorrectable link error may result in the loss of one of the control frames, leading to the formation of a congestion tree. The flow-monitoring agent may reset the link.

The flow-monitoring agent may generate a notification indicating the original point of congestion and the corrective operation (operation 212). The notification may be sent to the network management system or network operator, who may perform further diagnosis and/or corrective actions accordingly. In some examples, the flow-monitoring agent may report the original point of congestion by generating a RedFish event and adding a message to the switch controller log. A Redfish event is a notification generated by a Redfish-compliant system to inform monitoring applications about changes in the system's state, configuration, or hardware status. These events are part of the Redfish Event Service, which allows the network management system to subscribe to specific types of alerts and receive notifications in real-time.

If the node is a switch (e.g., an Ethernet switch), the flow-monitoring agent running on the switch controller may identify a number of potential transmitting ports on the switch for transmitting the flow downstream and checking whether TX stalling occurs at any port. In one example, when the flow-monitoring agent detects a stalled flow at an RX port, it may determine one or more potential downstream TX ports corresponding to the stalled flow based on the flow state (e.g., the IFCT/OFCT entries). The list may include a single port or all ports in the switch. An IFCT entry may point to an edge port in the switch, indicating that the end of a non-multicast flow has been reached, or it may correspond to an ordered, unicast flow and point to an OFCT entry at some port in the switch. Alternatively, the IFCT entry may correspond to an unordered, unicast flow and point to any number of OFCT entries at one or more ports in the switch. The IFCT entry may also correspond to a multicast flow and point to any number of OFCT entries and/or egress edge ports in the switch. If TX stalling is not detected at any downstream port, the flow-monitoring agent may determine that the node indeed comprises the original point of congestion.

In response to determining that the transmission of the flow is stalled (meaning that the congestion may originate from the current node or somewhere downstream), the flow-monitoring agent may send a trace-flow message associated with the flow to a downstream node (operation 214). The trace-flow message may assist the downstream node in identifying the original point of congestion. The downstream node may be a next-hop switch or a host. To send the trace-flow message, the flow-monitoring agent may first need to determine the downstream node for the stalled flow. In cases where flow channels are implemented, the flow-monitoring agent may trace the stalled flow downstream based on the corresponding FCT entries. More specifically, tracing the flow through a port downstream may involve following the flow's IFCT entry to OFCT entries on one or more ports and then following a OFCT entry corresponding to the stalled flow to an IFCT entry at a corresponding receiving port at the downstream next-hop switch.

The trace-flow message may be sent to the downstream next-hop switch via a mechanism that is not affected by the congestion. For example, the flow-monitoring agent may send the trace-flow message via an out-of-band channel, assign a special traffic class to the trace-flow message, or send the trace-flow message via an in-band channel as a control message (e.g., as a credit-control frame where credit-based flow control is used). The trace-flow message allows the downstream next-hop node to identify the original point of congestion, which may be the current node, the downstream node, or a different node that is further downstream.

When flow channels are implemented on a switch, each OFCT entry is associated with a single IFCT entry on a peer switch. The trace-flow message to the peer agent may include the flow ID corresponding to the OFCT, thus allowing the peer agent to check whether the corresponding IFCT entry is timed out (i.e., RX stalling on the peer switch). If RX stalling is detected, the tracing continues from the IFCT entry. Otherwise, the peer agent may determine that the upstream node or a link between the two nodes comprises the original point of congestion.

According to some aspects, upon receiving a trace-flow message from an upstream node, the flow-monitoring agent may determine whether RX stalling occurs on the port receiving the trace-flow message. If not, the flow-monitoring agent may determine that the flow has been traced to the original point of congestion, which may be the upstream node or the link between the upstream node and the current node. If RX stalling occurs on the port, the flow-monitoring agent may use the process shown in FIG. 2A to continue tracing the flow downstream until the root cause of congestion is determined.

FIG. 2B illustrates a process for determining the cause of a stalled flow based on a trace-flow message, according to one aspect of the instant disclosure. During operation, a node receives a trace-flow message associated with a flow at a receiving port (operation 222). The trace-flow message may be sent from the flow-monitoring agent running on an upstream node (e.g., a previous-hop switch) to indicate that TX stalling occurs at a corresponding TX port in the upstream node. Note that TX stalling may result from a node failure or backpressure from downstream.

The flow-monitoring agent running on the current node may determine whether the flow is stalled at the receiving port (operation 224). For example, the flow-monitoring agent may determine whether the detected stalling event occurs at the port receiving the trace-flow message (e.g., a timed-out IFCT entry).

If not, the flow-monitoring agent may determine that the upstream node or the link between the upstream node and the current node may comprise the original point of congestion (operation 226). Such a determination is made based on the fact that the upstream traffic is stalled but not the downstream traffic.

The flow-monitoring agent may further identify the original point of congestion and optionally perform a corresponding corrective operation (operation 234). The flow-monitoring agent may identify the root cause of the congestion by analyzing event logs or running diagnosis tests. For example, the node may have a hardware failure or certain configuration errors on the node. The flow-monitoring agent may identify the failed hardware component on the switch or the type of configuration errors. The switch controller may correct the identified configuration error automatically.

Subsequently, the flow-monitoring agent may generate a notification indicating the original point of congestion and the corrective operation (operation 236). The notification may be sent to the network management system or network operator, who may perform further diagnosis and/or corrective actions accordingly. In some examples, the flow-monitoring agent may report the original point of congestion by generating a RedFish event and adding a message to the switch controller log.

If the flow is stalled at the receiving port, the flow-monitoring agent may determine whether transmission of the flow is stalled (operation 228). For example, the flow-monitoring agent may detect a timed-out OFCT entry and determines that the transmission of the flow is stalled.

If the transmission of the flow is not stalled, the flow-monitoring agent may determine that the current node comprises the original point of congestion (operation 230). Such a determination is made based on the fact that the upstream traffic is stalled but not the downstream traffic.

The flow-monitoring agent may further identify the original point of congestion and optionally perform a corresponding corrective operation (operation 234). For example, the flow-monitoring agent may identify the root cause of the congestion by analyzing event logs or running diagnosis tests. If a configuration error is detected on a switch, the switch controller may correct the identified configuration error automatically.

Subsequently, the flow-monitoring agent may generate a notification indicating the original point of congestion and the corrective operation (operation 236). For example, the flow-monitoring agent may report the original point of congestion by generating a RedFish event and adding a message to the switch controller log.

If the transmission of the flow is stalled, the flow-monitoring agent may send a trace-flow message to a downstream node (operation 232). The process may repeat in the downstream direction along multiple nodes until the original point of congestion is identified.

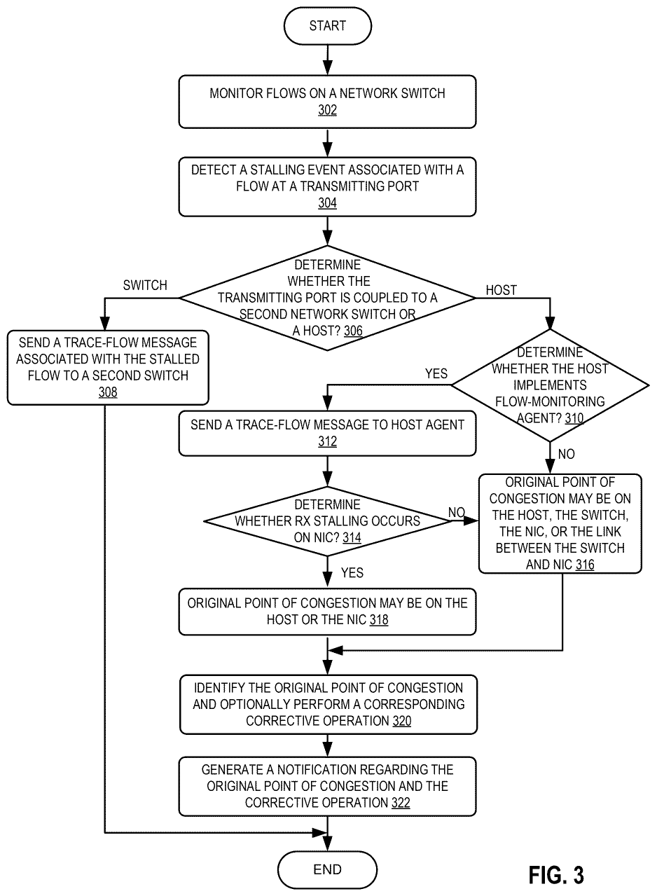

FIG. 3 presents a flowchart illustrating a process for determining the cause of a stalled flow in the transmitting direction, according to one aspect of the instant disclosure. During operation, a flow-monitoring agent monitors flows on a network switch (operation 302). When flow channels are used, each flow may be represented using a chain of Flow Channel Table (FCT) entries between source and destination.

The flow-monitoring agent may detect a stalling event associated with a flow at a transmitting port (operation 304). The network switch may be an Ethernet switch that maintains flow state at each port. The flow-monitoring agent may use the flow state to identify stalled flows (i.e., flows that are not making progress). In some examples, flow channels are used, and the flow-monitoring agent may monitor the flows by searching for timed-out entries in the FCTs.

The flow-monitoring agent may determine whether the transmitting port is coupled to a second network switch or a network interface controller (NIC) of a host (operation 306). The flow-monitoring agent may communicate with the link partner of the port to determine whether the link partner is a peer switch or a host. Alternatively, the network management system maintains the topology of the network and may indicate to the flow-monitoring agent on the switch whether the transmitting port is coupled to a switch or a host.

If the transmitting port is coupled to a second network switch, the flow-monitoring agent may send a trace-flow message associated with the stalled flow to the second network switch to allow the second network switch to continue tracing the flow downstream (operation 308). The trace-flow message may be sent via a mechanism that is not affected by the congestion.

If the transmitting port is coupled to a NIC of a host, the flow-monitoring agent may determine whether the host implements a flow-monitoring agent (operation 310). According to some aspects, each switch in the network runs a flow-monitoring agent, whereas a host may or may not implement a flow-monitoring agent. The flow-monitoring agent on the switch may communicate with the host to determine whether the host implements a flow-monitoring agent. Alternatively, the network management system maintains the configuration state of all devices (including switches and hosts) in the network and may notify the flow-monitoring agent on the switch whether a coupled host implements a flow-monitoring agent.

If the host implements a flow-monitoring agent, the flow-monitoring agent on the switch may send a trace-flow message to the agent on the host (operation 312). The trace-flow message may be sent via a mechanism that is not affected by the congestion.

The host agent may determine whether RX stalling occurs at the NIC (operation 314). The host agent may monitor the receiving port (e.g., by checking the depth of the receiving buffer) to determine whether stalling occurs at the receiving port of the NIC.

If RX stalling does not occur, the flow-monitoring agent on the switch may determine that the original point of congestion may include the host, the peer switch, the NIC, or the link between the peer switch and the NIC (operation 316). If RX stalling is observed at the NIC, the host agent may determine that the original point of congestion is the host or the NIC (operation 318). If the host does not implement the flow-monitoring agent, it may be determined that the original point of congestion may be the switch, the NIC, the link between the switch and the link, or the host (operation 316). These determinations are based on the fact that a device comprises the original point of congestion if the upstream traffic is stalled but not the downstream traffic.

The flow-monitoring agent on the switch or host may further identify the original point of congestion and optionally perform a corresponding corrective operation (operation 320). For example, the flow-monitoring agent may identify the root cause of the congestion by analyzing event logs or running diagnosis tests. If a configuration error is detected on a switch, the switch controller may correct the identified configuration error automatically.

Subsequently, the flow-monitoring agent may generate a notification indicating the original point of congestion and the corrective operation (operation 322). In some examples, the flow-monitoring agent may report the original point of congestion by generating a RedFish event and adding a message to the switch controller log.

In some examples, the host agent may detect TX stalling on the NIC and send a message to the flow-monitoring agent running on the peer switch to allow the switch agent to trace the flow downstream.

All or any portion of the operations shown in FIGS. 2A, 2B, and 3 may be performed, for example, by a device or set of devices (e.g., hosts or switches shown in FIG. 1). Although the example processes in FIGS. 2A, 2B, and 3 show specific orders for performing certain operations, the processes are not limited to such orders. Operations shown in succession in a flowchart may be performed in a different order and may be executed concurrently or with partial concurrence or combinations thereof.

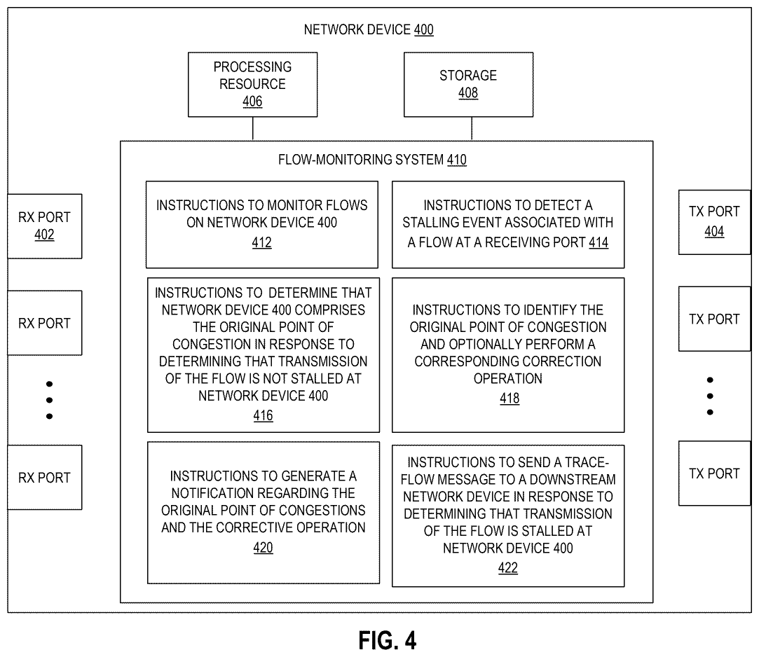

FIG. 4 illustrates a functional block diagram of a network device, according to one aspect of the instant disclosure. A network device 400 may include any physical device that allows hardware on a computer network to communicate and interact with one another. Examples of network device 400 may include a switch, a router, a gateway, an access point, a network interface card (NIC), a host device, etc. Network device 400 may include a number of communication ports, such as RX port 402 and TX port 404, for communicating with peer network devices.

Network device 400 may further include one or more processing resources (e.g., processing resource 406), one or more storage devices (e.g., storage device 408), and a flow-monitoring system 410. Network device 400 may include fewer or more entities than those shown in FIG. 4. In some examples, network device 400 may be a switch deployed in a network.

In the examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

Flow-monitoring system 410 may include any number of software units, hardware units, and firmware units that work together to achieve the goal of monitoring flows to detect and isolate the root cause of congestion. According to some aspects, flow-monitoring system 410 may include instructions that when executed by processing resource 406 may cause processing resource 406 to perform methods and/or processes described in this disclosure. Specifically, flow-monitoring system 410 may include instructions 412 to monitor flows on network device 400, as described above in relation to operation 202 shown in FIG. 2A. Instructions 412 may be used to monitor the state of each flow at each RX port and TX port. When flow channels are used, instructions 412 may include instructions to check the FCT entries, including the IFCT and OFCT entries at each port in the switch.

Flow-monitoring system 410 may include instructions 414 to detect a stalling event associated with a flow at a receiving port, as described above in relation to operation 204 shown in FIG. 2A. Examples of the stalling event may include but are not limited to: a hardware timeout event, the number of dropped packets exceeding a predetermined threshold, the number of stalled packets exceeding a predetermined threshold, utilization of a buffer exceeding a predetermined threshold, the backpressure sustained beyond a predetermined time threshold, or the exhaustion of credits. When flow channels are used, instructions 412 may include instructions to detect a timeout event associated with an FCT entry.

Flow-monitoring system 410 may include instructions 416 to determine that network device 400 comprises the original point of congestion in response to determining that transmission of the flow is not stalled at network device 400, as described above in relation to operations 206 and 208 shown in FIG. 2A. Furthermore, instructions 412 may include instructions to identify a number of potential transmitting ports for transmitting the flow downstream and instructions to determine whether transmission of the flow is stalled at any of the potential transmitting ports. When flow channels are implemented, instructions 412 may determine a number of potential downstream TX ports based on the IFCT entries of the RX port.

Flow-monitoring system 410 may include instructions 418 to identify the original point of congestion and optionally perform a corresponding corrective operation, as described above in relation to operation 210 shown in FIG. 2A. Instructions 418 may include instructions to read event logs on network device 400 to identify a hardware failure or a configuration error that causes the congestion. Instructions 418 may also include instructions that may automatically correct the configuration error.

Flow-monitoring system 410 may include instructions 420 to generate a notification regarding the original point of congestion and the corrective operation, as described above in relation to operation 212 shown in FIG. 2A. In some examples, instructions 420 may report the original point of congestion by generating a RedFish event and adding a message to the device log.

Flow-monitoring system 410 may include instructions 422 to send a trace-flow message associated with the flow to a downstream network device in response to determining that transmission of the flow is stalled at network device 400, as described above in relation to operations 206 and 214 shown in FIG. 2A. Upon receiving the trace-flow message, the downstream network device may trace the flow further downstream if it determines that network device 400 does not comprise the original point of congestion.

Flow-monitoring system 410 may include more instructions than those shown in FIG. 4. For example, flow-monitoring system 410 may include instructions to detect a stalling event associated with a flow at a transmitting port and to determine that a host or its NIC coupled to the transmitting port comprises the original point of the congestion in response to observing RX stalling at the NIC. In addition, flow-monitoring system 410 may include instructions to receive a trace-flow message associated with a flow from an upstream network device and instructions to determine that the upstream network device or a link between network device 400 and the upstream network device comprises the original point of congestion in response to determining that the flow is not stalled at the receiving port.

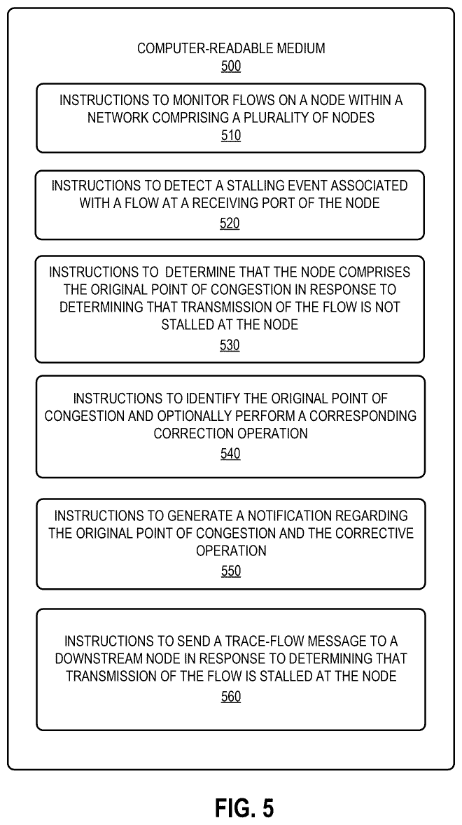

FIG. 5 illustrates a computer-readable medium (CRM) that facilitates the detection and isolation of the root cause of congestion, according to one aspect of the instant disclosure. CRM 500 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 500 may store instructions 510 to monitor flows on a node within a network comprising a plurality of nodes, as described above in relation to operation 202 shown in FIG. 2A; instructions 520 to detect a stalling event associated with a flow at a receiving port of the node, as described above in relation to operation 204 shown in FIG. 2A; instructions 530 to determine that the node comprises the original point of congestion in response to determining that transmission of the flow is not stalled at the node, as described above in relation to operations 206 and 208 shown in FIG. 2A; instructions 540 to identify the original point of congestion and optionally perform a corresponding corrective operation, as described above in relation to operation 210 shown in FIG. 2A; instructions 550 to generate a notification regarding the original point of congestion and the corrective operation, as described above in relation to operation 212 shown in FIG. 2A; and instructions 560 to send a trace-flow message associated with the flow to a downstream node in response to determining that transmission of the flow is stalled at the node, as described above in relation to operations 206 and 214 shown in FIG. 2A.

CRM 500 may include more instructions than those shown in FIG. 5. For example, CRM 500 may include instructions to detect a stalling event associated with a flow at a transmitting port and to determine that a host or its NIC coupled to the transmitting port comprises the original point of the congestion in response to observing RX stalling at the NIC. CRM 500 may further include instructions to receive a trace-flow message associated with a flow from an upstream node and instructions to determine that the upstream network device or a link between the node and the upstream node comprises the original point of congestion in response to determining that the flow is not stalled at the receiving port.

In general, the disclosure provides a solution to the problem of detecting and isolating the root cause of congestion in lossless networks, such as Ethernet networks employing Priority-based Flow Control (PFC). A distributed system may include flow-monitoring agents deployed on each switch within the network. The flow-monitoring agent may independently monitor received and transmitted traffic at each port to detect traffic stalls in both directions. In response to detecting a stalled flow, the agent may communicate with its peers (e.g., by sending a trace-flow message) to trace the flow downstream, from one agent to the next-hop agent until the root cause of congestion is determined. The trace-flow message may be sent using a mechanism not affected by the congestion. The agent on the root cause node may take corrective actions and report the problem and actions taken.

One aspect of the instant disclosure provides a system and method for detecting the root cause of congestion in a network. During operation, the system may monitor flows on a respective node within a network comprising a plurality of nodes, the node comprising a number of receiving ports and a number of transmitting ports. In response to detecting a stalling event associated with a flow at a receiving port, the system may determine whether transmission of the flow is stalled at the node. In response to determining that transmission of the flow is not stalled, the system may determine that the node comprises an original point of congestion causing the flow to stall. In response to determining that transmission of the flow is stalled, the system may send a trace-flow message associated with the flow to a downstream node, the trace-flow message facilitating the downstream node in identifying the original point of congestion.

According to a variation on this aspect, sending the trace-flow message may include sending the trace-flow message via an out-of-band channel, assigning a special traffic class to the trace-flow message, or sending the trace-flow message via an in-band channel as a control message, thereby preventing the trace-flow message from being affected by the congestion.

According to a variation on this aspect, the stalling event may include one or more of: a hardware timeout event; a number of dropped packets exceeding a predetermined threshold; a number of stalled packets exceeding a predetermined threshold; utilization of a buffer exceeding a predetermined threshold; backpressure sustained beyond a predetermined time threshold; or exhaustion of credits.

According to a variation on this aspect, the node is a network switch, and the system may identify a number of potential transmitting ports on the network switch for transmitting the flow downstream and determine that the network switch comprises the original point of congestion causing the flow to stall in response to determining that transmission of the flow is not stalled at any of the potential transmitting ports.

According to a further variation, the system may determine whether the transmitting port is coupled to a second network switch or a network interface controller (NIC) of a host in response to determining that transmission of the flow is stalled at a transmitting port. In response to the transmitting port being coupled to a second network switch, the system may send the trace-flow message to the second network switch.

According to a further variation, in response to the transmitting port being coupled to a first NIC of a first host that does not implement a flow-monitoring agent, the system may determine that the node, the first NIC, the first host, or a link between the first NIC and the node is the original point of congestion. In response to the transmitting port being coupled to a second NIC of a second host that implements a flow-monitoring agent, the system may determine whether the flow is stalled at a receiving port on the second NIC. In response to determining that the flow is stalled at the receiving port on the second NIC, the system may determine that the second host or second NIC comprises the original point of congestion. In response to determining that the flow is not stalled at the receiving port on the second NIC, the system may determine that the node, the second NIC, the second host, or a link between the second NIC and the node comprises the original point of congestion.

According to a variation on this aspect, the system may perform a corrective operation corresponding to an identified original point of congestion and generate a notification regarding the identified original point of congestion and the corrective operation.

According to a variation on this aspect, in response to receiving, at a second receiving port from an upstream node, a trace-flow message associated with a second flow, the system may determine whether the second flow is stalled at the second receiving port. In response to determining that the second flow is not stalled at the second receiving port, the system may determine that the upstream node or a link between the node and the upstream node comprises an original point of congestion causing the second flow to stall.

According to a variation on this aspect, the system may maintain flow channel tables for the receiving and transmitting ports on the node. Monitoring the flows may include tracking entries in the flow channel tables.

One aspect of the instant disclosure provides a network device. The network device may include a number of receiving and transmitting ports for coupling the network device to a plurality of network devices in a network, at least one processing resource, and a non-transitory computer-readable storage medium storing instructions that when executed by the processing resource cause the processing resource to perform a method. The method may include: monitoring flows on the network device; in response to detecting a stalling event associated with a flow at a receiving port, determining whether transmission of the flow is stalled at the node; in response to determining that transmission of the flow is not stalled, determining that the network device comprises an original point of congestion causing the flow to stall; and in response to determining that transmission of the flow is stalled, sending a trace-flow message associated with the flow to a downstream network device, the trace-flow message facilitating the downstream network device in identifying the original point of congestion.

One aspect of the instant disclosure provides a non-transitory computer-readable storage medium storing instructions which when executed by a processor cause the processor to perform a method. The method may include: monitoring flows on the network device; in response to detecting a stalling event associated with a flow at a receiving port, determining whether transmission of the flow is stalled at the node; in response to determining that transmission of the flow is not stalled, determining that the node comprises an original point of congestion causing the flow to stall; and in response to determining that transmission of the flow is stalled, sending a trace-flow message associated with the flow to a downstream node, the trace-flow message facilitating the downstream node in identifying the original point of congestion.

Within this disclosure, the term “switch” is used in a generic sense, and it can refer to any standalone or fabric switch operating in any network layer. “Switch” should not be interpreted as limiting aspects of the present invention to layer-2 networks. Any device that can forward traffic to an external device or another switch can be referred to as a “switch.” Any physical or virtual device (e.g., a virtual machine or switch operating on a computing device) that can forward traffic to an end device can be referred to as a “switch.” Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatuses. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art.

Additionally, the above disclosure is not intended to limit the aspects described herein. The scope of the aspects described herein is defined by the appended claims.

What is claimed is:

1. A computer-implemented method, the method comprising:
monitoring flows on a respective node within a network comprising a plurality of nodes, the node comprising a number of receiving ports and a number of transmitting ports;
in response to detecting a stalling event associated with a flow at a receiving port, determining whether transmission of the flow is stalled at the node;
in response to determining that transmission of the flow is not stalled, determining that the node comprises an original point of congestion causing the flow to stall; and
in response to determining that transmission of the flow is stalled, sending a trace-flow message associated with the flow to a downstream node, the trace-flow message facilitating the downstream node in identifying the original point of congestion.

2. The computer-implemented method of claim 1, wherein sending the trace-flow message comprises:
sending the trace-flow message via an out-of-band channel;
assigning a special traffic class to the trace-flow message; or
sending the trace-flow message via an in-band channel as a control message;
thereby preventing the trace-flow message from being affected by the congestion.

3. The computer-implemented method of claim 1, wherein the stalling event comprises one or more of:
a hardware timeout event;
a number of dropped packets exceeding a predetermined threshold;
a number of stalled packets exceeding a predetermined threshold;
utilization of a buffer exceeding a predetermined threshold;
backpressure sustained beyond a predetermined time threshold; or;
exhaustion of credits.

4. The computer-implemented method of claim 1, wherein the node is a network switch, and wherein the method further comprises:
identifying a number of potential transmitting ports on the network switch for transmitting the flow downstream; and
determining that the network switch comprises the original point of congestion causing the flow to stall in response to determining that transmission of the flow is not stalled at any of the potential transmitting ports.

5. The computer-implemented method of claim 4, further comprising:
in response to determining that transmission of the flow is stalled at a transmitting port, determining whether the transmitting port is coupled to a second network switch or a network interface controller (NIC) of a host; and
in response to the transmitting port being coupled to a second network switch, sending the trace-flow message to the second network switch.

6. The computer-implemented method of claim 5, further comprising:
in response to the transmitting port being coupled to a first NIC of a first host that does not implement a flow-monitoring agent, determining that the node, the first NIC, the first host, or a link between the first NIC and the node comprises the original point of congestion;
in response to the transmitting port being coupled to a second NIC of a second host that implements a flow-monitoring agent, determining whether the flow is stalled at a receiving port on the second NIC;
in response to determining that the flow is stalled at the receiving port on the second NIC, determining that the second host or second NIC comprises the original point of congestion; and
in response to determining that the flow is not stalled at the receiving port on the second NIC, determining that the node, the second NIC, the second host, or a link between the second NIC and the node comprises the original point of congestion.

7. The computer-implemented method of claim 1, further comprising:
performing a corrective operation corresponding to an identified original point of congestion; and
generating a notification regarding the identified original point of congestion and the corrective operation.

8. The computer-implemented method of claim 1, further comprising;
in response to receiving, at a second receiving port from an upstream node, a trace-flow message associated with a second flow, determining whether the second flow is stalled at the second receiving port;
in response to determining that the second flow is not stalled at the second receiving port, determining that the upstream node or a link between the node and the upstream node comprises an original point of congestion causing the second flow to stall.

9. The computer-implemented method of claim 1, further comprising maintaining flow channel tables for the receiving and transmitting ports on the node, and wherein monitoring the flows comprises tracking entries in the flow channel tables.

10. A network device, comprising:
a number of receiving and transmitting ports for coupling the network device to a plurality of network devices in a network;
at least one processing resource; and
a non-transitory computer-readable storage medium storing instructions that when executed by the processing resource cause the processing resource to perform a method, the method comprising:
monitoring flows on the network device;
in response to detecting a stalling event associated with a flow at a receiving port, determining whether transmission of the flow is stalled at the node;
in response to determining that transmission of the flow is not stalled, determining that the network device comprises an original point of congestion causing the flow to stall; and
in response to determining that transmission of the flow is stalled, sending a trace-flow message associated with the flow to a downstream network device, the trace-flow message facilitating the downstream network device in identifying the original point of congestion.

11. The network device of claim 10, wherein the stalling event comprises one or more of:
a hardware timeout event;
a number of dropped packets exceeding a predetermined threshold;
a number of stalled packets exceeding a predetermined threshold;
utilization of a buffer exceeding a predetermined threshold;
backpressure sustaining beyond a predetermined time threshold; or;
exhaustion of credits.

12. The network device of claim 10, wherein the network device is a switch, and wherein the method comprises:
identifying a number of potential transmitting ports on the switch for transmitting the flow downstream; and
determining that the switch comprises the original point of congestion causing the flow to stall in response to determining that transmission of the flow is not stalled at any of the potential transmitting ports.

13. The network device of claim 12, wherein the method further comprises:
in response to determining that transmission of the flow is stalled at a transmitting port, determining whether the transmitting port is coupled to a second network switch or a network interface controller (NIC) of a host;
in response to the transmitting port being coupled to a second network switch, sending the trace-flow message to the second network switch;
in response to the transmitting port being coupled to a first NIC of a first host that does not implement a flow-monitoring agent, determining that the node, the first NIC, the first host, or a link between the first NIC and the node comprises the original point of congestion;
in response to the transmitting port being coupled to a second NIC of a second host that implements a flow-monitoring agent, determining whether the flow is stalled at a receiving port on the second NIC;
in response to determining that the flow is stalled at the receiving port on the second NIC, determining that the second host or second NIC comprises the original point of congestion; and
in response to determining that the flow is not stalled at the receiving port on the second NIC, determining that the node, the second NIC, the second host, or a link between the second NIC and the node comprises the original point of congestion.

14. The network device of claim 10, wherein the method further comprises:
performing a corrective operation corresponding to an identified original point of congestion; and
generating a notification regarding the identified original point of congestion and the corrective operation.

15. The network device of claim 10, wherein the method further comprises:
in response to receiving, at a second receiving port from an upstream network device, a trace-flow message associated with a second flow, determining whether the second flow is stalled at the second receiving port;
in response to determining that the second flow is not stalled at the second receiving port, determining that the upstream node or a link between the node and the upstream node comprises a second original point of congestion causing the second flow to stall.

16. The network device of claim 10, wherein the method further comprises maintaining flow channel tables for the receiving and transmitting ports, and wherein monitoring the flows comprises tracking entries in the flow channel tables.

17. A non-transitory computer-readable storage medium storing instructions which when executed by a processor cause the processor to perform a method, the method comprising:
monitoring flows on a respective node within a network comprising a plurality of nodes, the node comprising a number of receiving ports and a number of transmitting ports;
in response to detecting a stalling event associated with a flow at a receiving port, determining whether transmission of the flow is stalled at the node;
in response to determining that transmission of the flow is not stalled, determining that the node comprises an original point of congestion causing the flow to stall; and
in response to determining that transmission of the flow is stalled, sending a trace-flow message associated with the flow to a downstream node, the trace-flow message facilitating the downstream node in identifying the original point of congestion.

18. The non-transitory computer-readable storage medium of claim 17, wherein the node is a network switch, and wherein the method comprises:
identifying a number of potential transmitting ports on the network switch for transmitting the flow downstream; and
determining that the network switch comprises the original point of congestion causing the flow to stall in response to determining that transmission of the flow is not stalled at any of the potential transmitting ports.

19. The non-transitory computer-readable storage medium of claim 18, wherein the method further comprises:
in response to determining that transmission of the flow is stalled at a transmitting port, determining whether the transmitting port is coupled to a second network switch or a network interface controller (NIC) of a host;
in response to the transmitting port being coupled to a second network switch, sending the trace-flow message to the second network switch;
in response to the transmitting port being coupled to a first NIC of a first host that does not implement a flow-monitoring agent, determining that the node, the first NIC, the first host, or a link between the first NIC and the node comprises the original point of congestion;
in response to the transmitting port being coupled to a second NIC of a second host that implements a flow-monitoring agent, determining whether the flow is stalled at a receiving port on the second NIC;
in response to determining that the flow is stalled at the receiving port on the second NIC, determining that the second host or second NIC comprises the original point of congestion; and
in response to determining that the flow is not stalled at the receiving port on the second NIC, determining that the node, the second NIC, the second host, or a link between the second NIC and the node comprises the original point of congestion.

20. The non-transitory computer-readable storage medium of claim 17, wherein the method further comprises:
in response to receiving, at a second receiving port from an upstream network device, a trace-flow message associated with a second flow, determining whether the second flow is stalled at the second receiving port;
in response to determining that the second flow is not stalled at the second receiving port, determining that the upstream node or a link between the node and the upstream node comprises a second original point of congestion causing the second flow to stall.
